(19) United States
(12) Patent Application Publication
(10) Pub. No.: US 2019/0022434 A1
(43) Pub. Date: Jan. 24, 2019

(54) BREATHING ASSEMBLY FOR AIRCRAFT

(71) Applicant: Zodiac Aerotechnics, Plaisir (FR)

(72) Inventors: Jean-Philippe Sibuet, Verneuil-sur-Seine (FR); Luc Pecastaing, Linas (FR)

(21) Appl. No.: 16/039,911

(22) Filed: Jul. 19, 2018

(30) Foreign Application Priority Data
Jul. 20, 2017 (FR) 1756884
Oct. 30, 2017 (FR) 1760257

(51) Int. Cl. A62B 25/00; A62B 7/14; A62B 18/08; A62B 18/02

(52) U.S. Cl. CPC A62B 25/005; A62B 7/14; B64D 10/00; A62B 18/02; B64D 2231/025; A62B 18/084

(57) ABSTRACT

Breathing assembly for aircraft, comprising:
breathing equipment for supplying breathing gas to a user, comprising:
   a breathing mask comprising a rigid support and a shell attached to the rigid support,
   a harness,
   a strap having a connecting portion attached to the harness,
   a retaining member attached to a retaining portion of the strap,
a storage unit comprising:
   a housing having an opening, and
   a closure device comprising at least one door,
   a biasing device able to act on the door to move it away from the opening when the closure device is in the closed position, and
   an engagement part able to engage with the retaining member to oppose the action of the biasing device and hold the closure device in the closed position, when the breathing equipment is in its stored position.

### CROSS-REFERENCE TO RELATED APPLICATIONS

This application claims the benefit of and priority to French Patent Application No. 1756884 (“the '884 application”), filed on Jul. 20, 2017, and French Patent Application No. 1760257 (“the '257 application”), filed on Oct. 30, 2017. The '884 and '257 applications are hereby incorporated in their entireties by this reference.

### FIELD OF THE DISCLOSURE

The invention relates to a breathing assembly for aircraft. More specifically, according to the invention, said breathing assembly is of the type essentially comprising breathing equipment provided with an inflatable harness and a storage unit.

In particular, the invention relates to a breathing assembly for aircraft, comprising:

breathing equipment for supplying breathing gas to a user, comprising:
a rigid support,
a shell attached to the rigid support, the shell having a breathing cavity and being adapted for application to the user's face around the user's mouth and nose,
a harness adapted to extend around the user's head opposite the shell in order to hold the shell on the user's face,
a strap having a gripping portion and a connecting portion, the connecting portion being attached to the harness,

a storage unit comprising:
a housing adapted to receive the breathing equipment in a stored position, said housing having an opening, and
a closure device comprising at least one door having an inner face and an outer face, the closure device being movable between a closed position where the closure device at least partially closes the opening and an open position where it is at least partially clear of the opening and allows removing the breathing equipment from the storage unit.

Such a breathing assembly is described in WO2013/064856A1. The breathing equipment conventionally used by the crew of the aircraft must be placed quickly and securely on the pilot's head. This operation must only require one hand, as the other hand is often needed for other essential tasks.

For example, if, due to pressurization failure, an aircraft pilot must quickly put on his or her breathing equipment in order to be supplied with the oxygen needed to breathe, this often must be done with one hand while the other hand is busy controlling the aircraft. The use of an inflatable head harness has therefore been suggested to allow positioning the breathing equipment with one hand. Generally, the head harness is substantially domed or annular in shape and is expanded diametrically by the introduction of pressurized gas which increases the size of the harness to position it on the user's head. The flow of gas is controlled by a valve attached to the breathing equipment, and after expansion of the harness, the breathing equipment is placed against the user's face, the harness being expanded and at a distance from the back of the head. Once the breathing equipment is properly positioned, the pressure in the harness is released, which causes the harness to contract and come into contact with the pilot's head (lightly grasping it), holding the breathing equipment in its proper position. Meanwhile, the other hand of the pilot is free to control the aircraft or perform other tasks that may be required.

The strap ensures that when storing the breathing equipment in the storage unit, the harness is outside the cavity of the breathing equipment. This reduces the risk of a loop of the harness inserting itself into the cavity of the breathing equipment when the harness begins to inflate, reducing the risk of a problem occurring during inflation of the harness.

The invention aims to provide better safety related to the necessity for putting on the breathing equipment within a short time.

### DESCRIPTION OF THE DISCLOSURE

For this purpose, according to the invention, the breathing assembly has the following features:

the storage unit further comprises a biasing device able to act on the door to move the door away from the opening when the closure device is in the closed position,

the breathing equipment further comprises a retaining member attached to a retaining portion of the strap, and

the storage unit comprises an engagement part able to engage with the retaining member to oppose the action of the biasing device and hold the closure device in the closed position, when the breathing equipment is in its stored position.

Thus, when the strap has been used to position the harness correctly relative to the breathing mask, the retaining member holds the closure device in the closed position. If the harness has not been correctly positioned relative to the breathing mask, the retaining member does not hold the closure device in the closed position. The user can easily check if the harness has been correctly positioned, by checking the state of the closure device (of the door). In addition, the closure device must be in the closed state for a pilot to be authorized for takeoff. Safety is therefore increased.

According to another feature of the invention, the engagement part preferably extends over the outer face of the door and abuts against the retaining member when the breathing equipment is in the stored position.

This solution is simple and robust.

According to a complementary feature of the invention, preferably the closure device provides a passage when in the closed position and the strap extends through the passage of the closure device, and the retaining member is a rod extending against the outer face of the door.

According to an alternative feature of the invention, the retaining member preferably forms a hook, and more preferably the closure device provides a passage when in the closed position, and the hook comprises a core and a stop surface, and when the breathing equipment is in the stored position the core extends through the passage and the stop surface bears against the outer face.

According to another feature of the invention, preferably the door is generally flat and has a periphery, the door having an inward cutout (notch) in its periphery to form said passage.

According to yet another feature of the invention, preferably said door is a first door, the closure device further comprises a second door, and the biasing device is able to act on each of the first and second doors to move them away from the opening when the closure device is in the closed position.

According to an alternative feature of the invention, preferably said door is a first door, the closure device further comprises a second door, and the biasing device is only able to act on the first door to move it away from the opening when the closure device is in the closed position.

According to another feature of the invention, preferably:

the storage unit further comprises a retaining device having an active state and an inactive state,

the retaining device is able to oppose the action of the biasing device and keep the closure device in the closed position, when the retaining device is in the active state,

the retaining device is in the active state when the breathing mask is out of the storage unit (in particular when worn by the user), and

the retaining device is in the inactive state when the breathing equipment is in the stored position.

The doors of the storage unit are thus kept closed during use of the breathing mask, which prevents damage to the storage unit and prevents the doors from impeding the user (pilot).

According to a complementary feature of the invention, the retaining device is preferably breakable (the retaining device has a localized snap-off area/a mechanically weakened area) in order to release the closure device when the user pulls manually (force of about 50 N) on the door.

Thus, in case of emergency or failure of the retaining device, the breathing equipment will not remain stuck inside the housing of the storage unit.

According to another feature of the invention, preferably the retaining member obstructs the biasing device when it is engaged with the engagement part.

Thus, as the retaining member is not blocking the door but blocks the action of the biasing device, the risk that the retaining member will retain the door when the user wants to remove the breathing mask from the housing (when needed) is eliminated.

According to a complementary feature of the invention, the engagement part is preferably connected to the housing. In particular, the retaining member could act on a movable element against which the biasing element comes to bear.

According to another feature of the invention, preferably the biasing device has an active state and an inactive state, the biasing device being in the active state when the breathing equipment is in the stored position, and the biasing element being in the inactive state when the breathing equipment is out of storage.

According to another feature of the invention, the door is preferably pivotally mounted on the housing.

According to yet another feature of the invention, preferably the assembly further comprises a supply valve and a fluid supply hose extending between the supply valve and the breathing mask, and the breathing assembly is adapted to close the supply valve when the door is at least partially closing the opening and to open said supply valve when the door is away from the opening.

According to yet another feature of the invention, the strap is preferably elastically extensible, more preferably able to elongate elastically by at least 30%.

In order to solve the aforementioned problem presented by a breathing assembly of the type described in document WO2013/064856A1, additionally or alternatively to the features mentioned above, according to the invention the strap comprises a main arm extending between the gripping portion and the connecting portion and a retaining arm extending between a retaining portion fixed to the shell and a central portion attached to the main arm.

In the case of alternative features to solve the aforementioned problem, the breathing equipment further comprises a retaining member connected to a retaining portion of the strap. In this case, the retaining member of the strap could be retained on an engagement part of either the storage unit or the breathing mask (by abutment, releasable self-gripping system, or similar), in order to maintain the breathing equipment in the stored position.

Thus, the risk that the retaining member of the strap is properly retained on the engagement part while the breathing equipment is in fact not held in the correct stored position (satisfactory positioning of the harness relative to the breathing mask) is reduced.

According to a complementary feature of the invention, preferably the shell comprises a peripheral support supporting a transparent lens and the retaining portion is fixed to the peripheral support.

This simple solution has proven effective in ensuring satisfactory positioning of the strap.

According to yet another complementary feature of the invention, preferably the peripheral support comprises an upper edge portion extending above the transparent lens, and the retaining portion is fixed to the peripheral support near the upper edge portion.

Thus, the part of the strap that comprises the main arm and the retaining arm will extend between the harness and the upper edge portion of the peripheral support and, by bearing on the top of the user's head, will position the harness vertically relative to the user's head.

According to the invention, preferably the breathing assembly also has the following features:

the main arm of the strap has a first distance between the connecting portion attached to the harness and the central portion,

the retaining arm has a second distance between the retaining portion fixed to the shell and the central portion, and

the second distance is between one half and twice the first distance.

Thus, the risk that the breathing equipment is not in a satisfactory position in the storage unit is further reduced.

According to the invention, preferably the breathing assembly also has the following features:

the harness comprises an upper tube and a lower tube,

the connecting portion constitutes a first connecting portion connected to an attachment portion of the upper inflatable tube,

the strap further comprises a secondary arm comprising a second connecting portion, the second connecting portion being connected to a linking portion of the lower inflatable tube,

the secondary arm is not fixed to the upper inflatable tube.

Thus, the risk that either the upper tube or the lower tube of the harness is (improperly) positioned in the breathing cavity is reduced.

Additionally according to the invention, preferably:

the secondary arm is connected to an intermediate portion of the main arm,

the intermediate portion is distanced from the first connecting portion by an intermediate distance,

the retaining portion is a distanced from the first connecting portion by a total length, and

the intermediate distance is more than 20% of the total length.

According to another feature of the invention, preferably the harness comprises an extensible tube, the shell comprises a peripheral support supporting a transparent lens, and the extensible tube is held on the peripheral support by a retaining tab.

The correct positioning of the harness in the stored position is thus further ensured.

According to a complementary feature of the invention, preferably the peripheral support comprises a side edge portion, and the retaining tab is fixed to the side edge.

According to another complementary feature of the invention, preferably the retaining tab is flexible and has a length of less than 3 centimeters.

### BRIEF DESCRIPTION OF THE FIGURES

Other features and advantages of the invention will become apparent from the following detailed description, with reference to the accompanying drawings in which:

FIG. 1 illustrates a perspective view of a portion of a breathing assembly comprising breathing equipment and a storage unit according to a first embodiment of the invention, during a first storage step,

FIG. 2 illustrates a plan view of the breathing assembly, the breathing equipment comprising a harness placed in a storage position on a breathing mask, during insertion of the breathing equipment into the storage unit,

FIG. 3 illustrates the breathing equipment with the harness placed in the storage position on the breathing mask and the breathing mask placed in a stored position in the storage unit,

FIG. 4 illustrates the breathing equipment as it exits the storage unit,

FIG. 5 illustrates the breathing equipment in a usage position,

FIG. 6 illustrates part of the breathing equipment at the arrow denoted VI in FIG. 2,

FIG. 7 illustrates the breathing assembly at the arrow denoted VII in FIG. 3,

FIG. 8 schematically illustrates the storage unit in perspective view, when the breathing equipment is not properly stored in the storage unit,

FIG. 9 illustrates a portion of FIG. 8 on a larger scale,

FIGS. 10A and 10B illustrate two embodiments of a retaining member for the breathing equipment,

FIG. 11 represents a portion of the breathing assembly at the arrow denoted XI in FIG. 3, and illustrates a retaining device in an active state,

FIG. 12 illustrates the retaining device of FIG. 11 in an inactive state,

FIG. 13 illustrates a perspective view of the breathing equipment of a breathing assembly according to a second embodiment of the invention,

FIG. 14 illustrates the breathing assembly according to the second embodiment, in accordance with FIG. 7,

FIG. 15 represents a portion of the breathing assembly according to the second embodiment, in accordance with FIG. 11, and illustrates a retaining device in an active state,

FIG. 16 illustrates the retaining device according to the second embodiment, in accordance with FIG. 12, in an inactive state,

FIG. 17 schematically represents a breathing assembly according to a third embodiment of the invention, in a section view along the line denoted XVII in FIG. 19, the breathing equipment being in the usage position,

FIG. 18 schematically represents the breathing assembly according to the third embodiment, the breathing equipment being in the stored position,

FIG. 19 schematically represents the storage unit of the breathing assembly according to the third embodiment, as viewed along the arrow denoted XIX in FIG. 17.

### DETAILED DESCRIPTION OF THE EMBODIMENTS

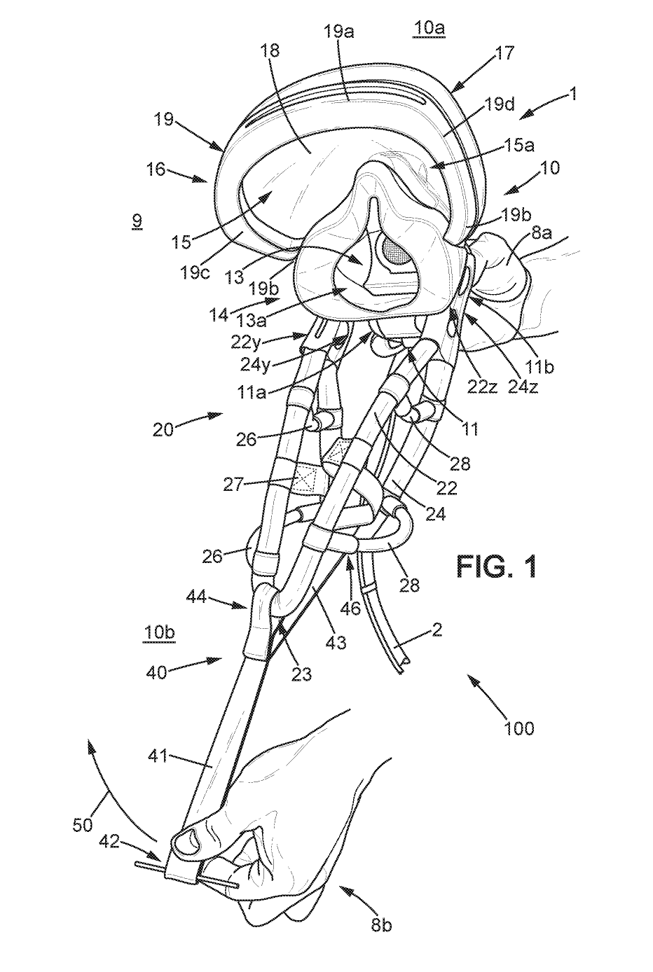

FIGS. 1 to 12 illustrate a first embodiment of a breathing assembly 1 placed in a cockpit 9 of an aircraft and essentially comprising breathing equipment 100 and a storage unit 30.

The breathing equipment 100 comprises a breathing mask 10, an inflatable harness 20, a strap 40, and a retaining member 70, 70′, 70″, 70′″.

The breathing mask 10 shown in FIGS. 1 to 5 comprises a support 11, a demand regulator 1, a shell attached to the support 11, and a transparent lens 18.

The support 11 is rigid, supports the shell, and forms a housing containing the demand regulator 12. The support 11 comprises two opposite gripping surfaces 11a, 11b. In order to hold the breathing mask 10, the user 8 can squeeze the support 11 by pressing on the two gripping surfaces 11a, 11b. The gripping surface 11a is part of a lever that can turn slightly when firmly pressed.

In the illustrated embodiment, the breathing mask 10 comprises an oral/nasal (oronasal) piece 14 and an optional eye shield 16, the eye shield 16 being removably attached to the oral/nasal piece 14. Alternatively, the oral/nasal piece 14 and the eye shield 16 could be an inseparable whole.

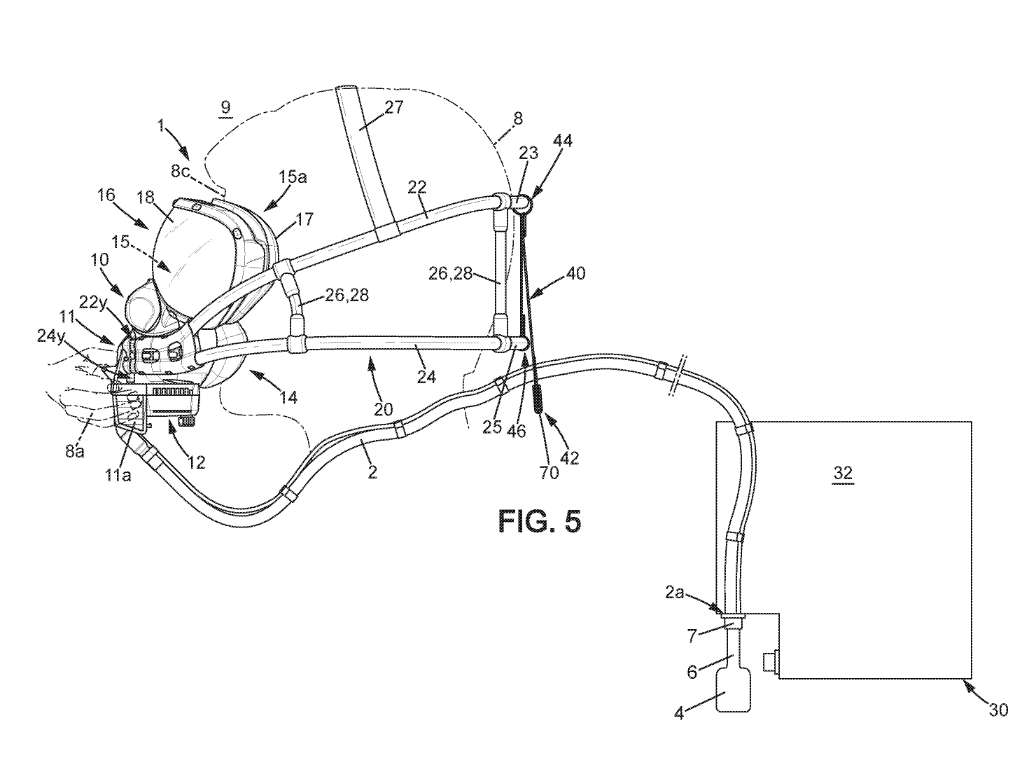

As shown in particular in FIGS. 1 and 5, the eye shield 16 comprises the transparent lens 18 and a peripheral support 17 extending around the transparent lens 18 and supporting the transparent lens 18. The peripheral support 17 has an edge 19 comprising an upper edge portion 19a, a lower edge portion 19b opposite the upper edge portion 19a, and side edge portions 19c, 19d extending between the upper edge portion 19a and the lower edge 19b.

The shell comprises the oral/nasal piece 14 and the peripheral support 17.

The breathing mask 10 has a front side 10a and a rear side opposite the front side 10a. As shown in FIG. 1, the oral/nasal piece 14 comprises a cavity 13 having an opening 13a in the rear side 10b of the breathing mask 10. The eye shield 16 comprises a cavity 15 having an opening 15a on the rear side 10b of the breathing mask 10. In this embodiment, the cavity 15 of the eye shield 16 is in communication with the cavity 13 of the oral/nasal piece 14 when the eye shield 16 is attached to the oral/nasal piece 14. In the variant where the oral/nasal piece 14 and the eye shield 16 constitute an inseparable assembly, the cavity 15 of the eye shield 16 and the cavity 13 of the oral/nasal piece 14 are always in communication with one another and generally there is no separation between the cavity 15 of the eye shield 16 and the cavity 13 of the oral/nasal piece 14, so that they form a single cavity.

The opening 15a is surrounded by the peripheral support 17. As shown in FIG. 5, in the usage position the rear side 10b of the breathing mask 10 is intended to be applied to the face 8c of a user 8 to form a seal. In the usage position, the oral/nasal piece 14 is applied to the face 8c of the user 8 to form a seal around the nose and mouth of the user 8, so that the user 8 breathes the breathing gas which is in the cavity 13, via the opening 13a. In addition, in the usage position, the peripheral support 17 is applied to the face 8c of the user 8 around the eyes, so that the opening 15a is closed off by the face 8c of the user 8. The opening 15a lies substantially in the plane of separation extending between the front side 10a and the rear side 10b of the breathing mask 10.

The breathing equipment 1 further comprises a gas supply tube 2. The gas supply tube 2 is flexible and comprises an upstream end 2a and a downstream end 2b. The gas supply tube 2 is connected at the upstream end 2a to a source of pressurized breathing gas 4 (in particular a source of oxygen) via a feed line 6 and a supply valve 7. The downstream end 2b of the gas supply tube 2 is connected to the regulator 12, so that the cavity 13 of the oral/nasal piece 14 is supplied with breathing gas through the regulator 12 upon demand by the user as he or she breathes.

The harness 20 comprises an upper inflatable tube 22 and a lower inflatable tube 24, each of the upper inflatable tube 22 and lower inflatable tube 24 forming a loop having a first end 22y, 24y and a second end 22z, 24z connected to the support 11. As shown in FIG. 5, in the usage position, each of the upper inflatable tube 22 and lower inflatable tube 24 surrounds the head of the user 8. The regulator 12 comprises a valve for selectively connecting an inner chamber of the upper inflatable tube 22 and lower inflatable tube 24 to a source of pressurized gas in order to inflate the harness 20 upon actuation of the lever comprising the gripping surface 11a or to the ambient air of the cockpit 9 in order to deflate the harness 20 when the lever comprising the gripping surface 11a is released. In the illustrated embodiment, the source of pressurized gas supplying the upper inflatable tube 22 and lower inflatable tube 24 is the source of breathing gas 4 as described for example in WO99/58197. In an alternative embodiment, the upper inflatable tube 22 and lower inflatable tube 24 may be supplied with pressurized gas by an autonomous source of pressurized gas as described for example in WO2008/017630.

The harness 20 further comprises non-inflatable elements forming cross-pieces 26, 28, each connected at an upper end to the upper inflatable tube 22, away from the first end 22y and second end 22z of the upper inflatable tube 22, and at a lower end to the lower inflatable tube 24, away from the first end 24y and second end 24z of the lower inflatable tube 24. The cross-pieces 26, 28 are of elastic material, such as rubber or elastomer. Preferably, the cross-pieces 26, 28 have a tubular shape of circular cross-section.

The harness 20 further comprises a side strap 27 connected at each of its two ends to the upper inflatable tube 22. The side strap 27 extends over the head of the user 8 in the usage position.

The strap 40 comprises a gripping portion 42, a retaining portion 48, a first connecting portion 44 connected to an attachment portion 23 of the upper inflatable tube 22, and a second connecting portion 46 connected to an attachment portion 25 of the lower inflatable tube 24.

The strap 40 comprises a main arm 41 and a secondary arm 43. The main arm 41 extends from the retaining portion 48 to the first connecting portion 44. In the first embodiment, illustrated in FIGS. 1 to 12, the secondary arm 43 extends from the first connecting portion 44 to the second connecting portion 46, in other words the second connecting portion 46 is connected to the retaining portion 48 through the secondary arm 43, then through the main arm 41. More specifically, the gripping portion 42 and/or the retaining portion 48 form a free end of the strap 40, the second connecting portion 46 forms an opposite end of the strap 40, and the first connecting portion 44 is intermediate between the gripping portion 42 and/or the retaining portion 48 and the second connecting portion 46 of the strap 40. As a variant, the secondary arm 43 could extend from the second connecting portion 46 of the strap to the retaining portion 48, so that the second connecting portion 46 is connected to the retaining portion 48 independently of the main arm 41.

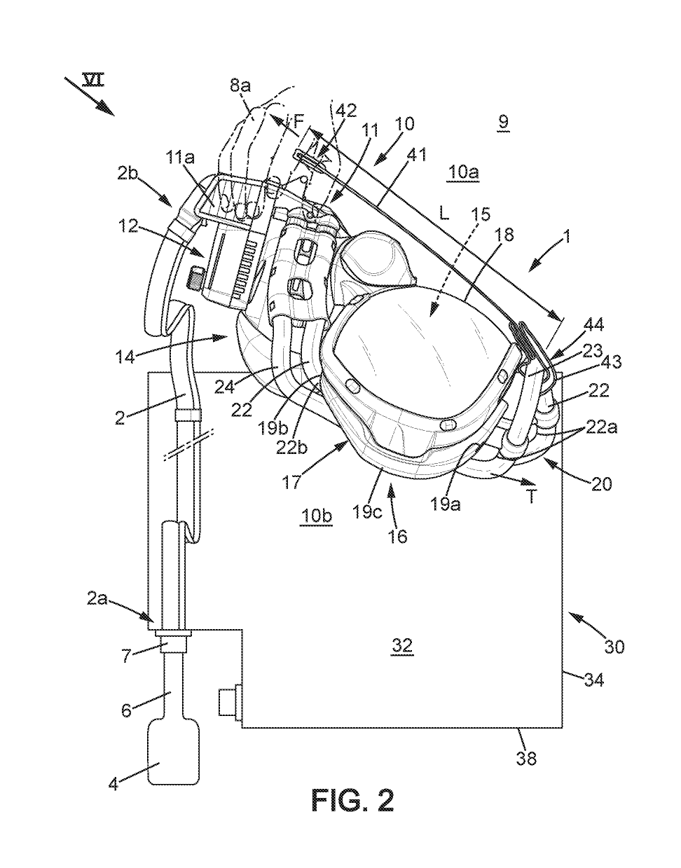

The strap 40 is advantageously elastically extensible, so that the user 8 can easily apply tensile force T on the harness 20 by pulling on the gripping portion 42 of the strap 40, as illustrated by arrow F in FIG. 2.

The first connecting portion 44 is connected to the upper inflatable tube 22 substantially in the middle of the upper inflatable tube 22 between the first end 22y and the second 22z end, the attachment portion 23 being substantially at the top of the loop formed by the upper inflatable tube 22. The second connecting portion 46 is connected to the lower inflatable tube 24 substantially in the middle of the lower inflatable tube 24 between the first end 24y and the second end 24z, the attachment portion 25 being substantially at the top of the loop formed by the lower inflatable tube 24. Thus, the tensile force F exerted on the strap 40 results in substantially uniform tension T on the upper 22 and lower 24 inflatable tubes.

The storage unit 30 comprises a housing 32 delimited by a rear wall 38 and a peripheral wall 34. In the first embodiment, illustrated in FIGS. 1 to 12, the rear wall 38 is intended to rest on the floor of the cockpit 9, so that the rear wall 38 forms the bottom of the housing 32. The housing 32 is in communication with the ambient air of the cabin 9 via an opening 36 opposite the rear wall 38.

In the first embodiment, shown in FIGS. 1 to 12, the storage unit 30 defines a storage box. The storage unit 30 comprises a closure device 50 having at least one door, preferably two doors 52, 54, hinged on the housing 32 to move between an open position and a closed position in order to selectively close the opening 36. The doors 52, 54 each have an inner face 52a, 54a and an outer face 52b, 54b. The doors 52, 54 are generally flat and have a periphery 55. Preferably, the doors comprise a passage 56 through which the support 11 extends when the breathing equipment is in the stored position, so that the user can grasp the support 11 of the breathing mask 10 without opening the doors 52, 54, as shown in FIG. 7. When the doors 52, 54 are closed, the supply valve 7 is closed. When one or both of the doors 52, 54 is open, the supply valve 7 is automatically opened in order to feed the breathing mask 10.

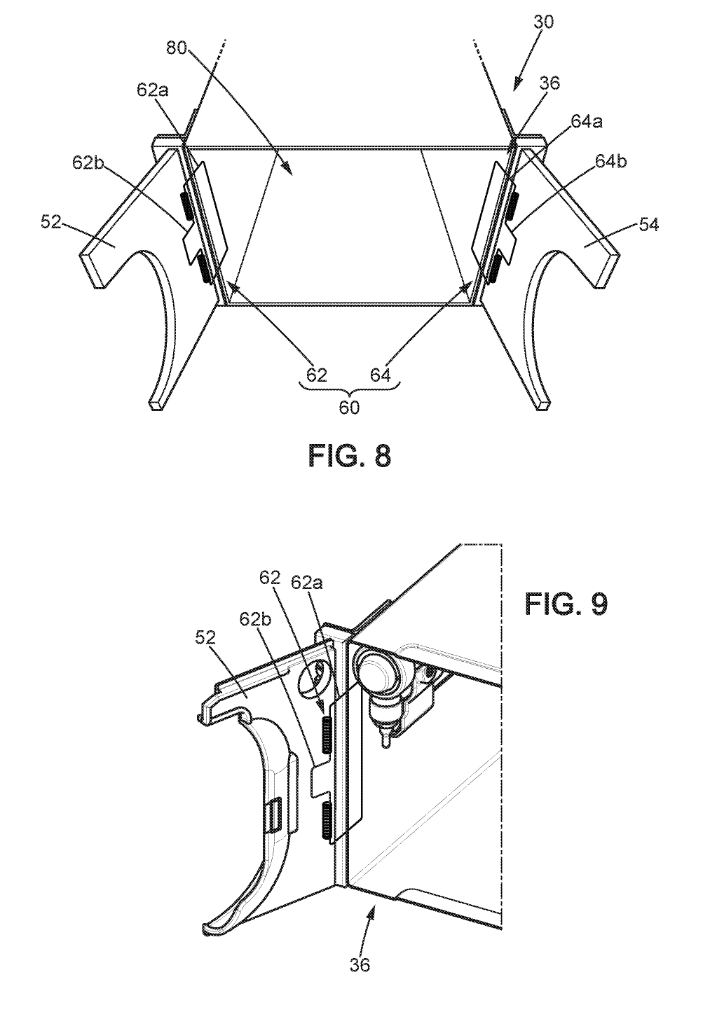

The storage unit 30 further comprises a biasing device 60. The biasing device 60 replaces or supplements the bistable spring system that conventionally holds the doors 52, 54 in the open position or the closed position. The biasing device 60 urges each of the doors 52, 54 towards the open position. In the illustrated embodiment, the biasing device 60 comprises a spring 62, 64, preferably a torsion spring, for each of the doors 52, 54, as illustrated in particular in FIGS. 8 and 9. Each spring 62, 64 comprises a first portion 62a, 64a bearing against the housing 32 and a second portion 62b, 64b bearing against the respective door 52, 54.

The breathing assembly 1 further comprises a retaining member 70 held by a retaining portion 48 of the strap 40. The retaining portion 48 is preferably arranged close to the gripping portion 42. In the first embodiment, illustrated in FIGS. 1 to 9, the gripping portion 42 is arranged between the retaining portion 48 and the first connecting portion 44. Alternatively, the retaining portion 48 could be arranged between the gripping portion 42 and the first connecting portion 44.

To store the breathing mask 10 in the storage unit 30, as shown in FIG. 1, first the user 8 holds the support 11 with a first hand 8a, and pulls on the strap 40 by the gripping portion 42 (or the retaining portion 48) with a second hand 8b. Thus, the user 8 grips the support 11 with the first hand 8a by pressing on the opposite surfaces 11a, 11b on the front side 10a of the breathing mask 10, grips the gripping portion 42 (or the retaining portion 48) of the strap 40 on the rear side 10b of the breathing mask 10, and moves both hands away from each other. As a result, the user 8 simultaneously pulls on the attachment portion 23 of the first inflatable tube 22 (via the main arm 41 of the strap 40) and on the attachment portion 25 of the second inflatable tube 24 of the breathing equipment 100 (via the secondary arm 43 of the strap 40) at a distance from the breathing mask 10 and in particular at a distance from the cavity 15 of the eye shield 16 and the cavity 13 of the oral/nasal piece 14 respectively.

Then, the second hand 8b of the user 8 makes a preferably substantially semicircular motion above the breathing mask 10 while pulling on the attachment portions 23, 25 of the harness 20. As a result, the user 8 pulls successively on the gripping portion 42 of the strap 40 far from the front face 10a, above the upper edge 19a and then the front side 10a near the support 11.

The main arm 41 of the strap 40 has a length between the gripping portion 42 and the first connecting portion 44 which is long enough to allow the gripping portion to be placed on the support 11 when the harness 20 is in the storage position. Similarly, the secondary arm 43 of the strap 40 has a length between the first connecting portion 44 and the second connecting portion 46 that is sufficiently long to allow the gripping portion 42 to be placed on the support 11 when the harness 20 is in the storage position.

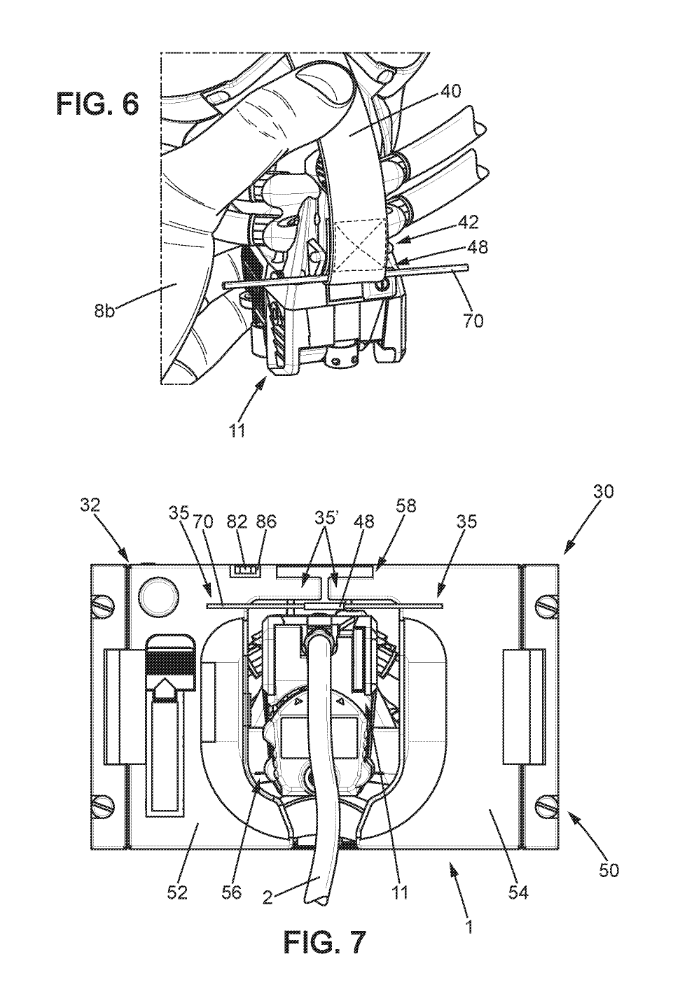

Thus, as shown in FIG. 2, the user 8 then pulls on the gripping portion 42 of the strap 40 and holds the support 11 with the same hand 8a. The harness 20 is therefore in a storage position where two upper bearing portions 22a of the upper inflatable tube 22 rest on the upper edge portion 19a of the eye shield 16, and two lower bearing portions 22b of the upper inflatable tube 22 rest on the lower edge portion 19b of the eye shield 16. For legibility, the second hand 8b is shown slightly to the side in FIG. 6.

The user 8 exerts tensile force F on the main arm 41 of the strap 40, which causes tension T on the harness 20 between the upper bearing portions 22a and the lower bearing portions 22b of the upper inflatable tube 22, thus preventing the upper inflatable tube 22 from entering the cavity 15.

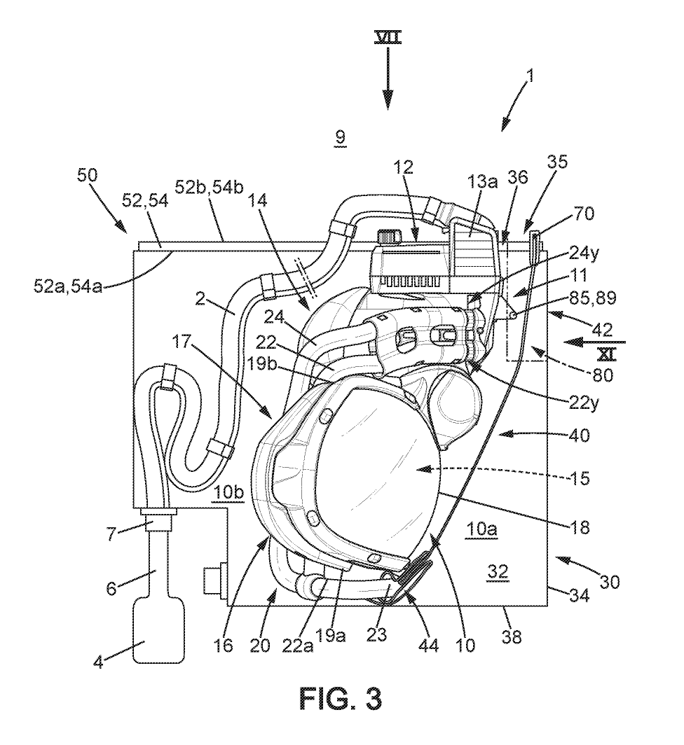

In FIGS. 2 and 3, the upper bearing portions 22a of the upper inflatable tube 22 are shown slightly distanced from the upper edge 19a of the eye shield 16, to make the representation more understandable. However, the upper bearing portions 22a of the upper inflatable tube 22 in fact rest on the upper edge portion 19a of the eye shield 16.

Next, the user 8 inserts the breathing mask 10 into the housing 32 of the storage unit 30 while pulling on the strap 40 to hold the harness 20 in the storage position, and places the breathing equipment 100 in the stored position shown in FIG. 3.

In the first embodiment shown in FIGS. 1 to 12, where the rear wall 38 is the bottom wall of the housing 32, when the breathing mask 10 is in the stored position, the eye shield 16 of the breathing mask 10 rests on the rear wall 38 of the housing 32 by means of the upper bearing portions 22a of the upper inflatable tube 22 which is held between the upper edge 19a of the breathing mask 10 and the rear wall 38.

As shown in FIG. 3, the breathing equipment 100 is stored in the housing 32 of the storage unit 30 in the stored position and the harness 20 is held in the storage position on the breathing mask 10.

The user 8 then closes the doors 52, 54 and places the retaining member 70 against an engagement part 35 of the closure device 30. In the first embodiment illustrated in FIGS. 1 to 12, the retaining member 70 is a rod. The engagement part 35 extends over the outer face 52b, 54b of each of the doors 52, 54. The main arm 41 of the strap 40, in particular the gripping portion 42, extends through the passage 56.

The retaining member 70 thus holds the doors 52, 54 closed against the action of the springs 62, 64, by means of the main arm 41 and the secondary arm 43 of the strap 40 which are held taut at their opposite end (first connecting portion 44 and second connecting portion 46) to the harness 20, as shown in FIG. 7.

As shown in FIG. 8, if the retaining member 70 is not positioned against the engagement part 35 of the closure device 30, the doors 52, 54 are opened by the action of the biasing device 60.

The distance between the first connecting portion 44, which connects the strap 40 to the upper inflatable tube 22 of the harness 20, and the retaining portion 48, by which the strap 40 holds the doors 52, 54 closed via the retaining member 70, in other words the length of the main arm 41 of the strap 40, must be short enough to prevent the retaining member 70 from contact with the engagement part 35 when the upper inflatable tube 22 of the harness 20 is not correctly positioned relative to the breathing mask 10 and in particular relative to the cavity 15. In the first embodiment illustrated in FIGS. 1 to 12, the distance between the second connecting portion 46 which connects the strap 40 to the lower inflatable tube 24 of the harness 20, and the first connecting portion 44 which connects the secondary arm 43 of the strap 40 to the main arm 41 of the strap 40, must be short enough to prevent the lower inflatable tube 24 of the harness 20 from being improperly positioned relative to the breathing mask 10 and in particular relative to the cavity 13.

Alternatively, instead of a simple contact between the retaining member 70 and the engagement part 35, a clipping system could be provided. Preferably, to assist the user, the shape and color of the retaining member 70 and engagement part 35 correspond to each other.

When needed, the user 8 grasps the breathing mask 10 by the support 11 and pulls the breathing mask 10 towards himself or herself through the opening 36. The tension in the strap 40 decreases, allowing the doors 52, 54 to open.

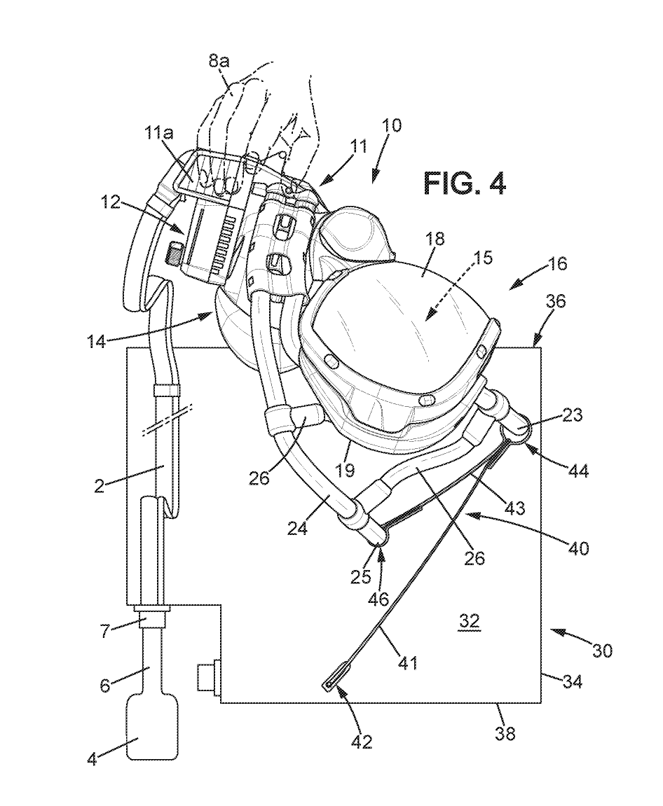

In the illustrated embodiment, the user 8 then rotates the breathing mask 10 by pulling the breathing mask 10 towards himself or herself, as shown in FIG. 4. The harness 20 unfolds gradually and drops due to gravity. The lower inflatable tube 22 and the lower inflatable tube 24 of the harness 20 are thus respectively kept away from the cavity 15 of the eye shield 16 and the cavity 13 of the oral/nasal piece 14.

Next, the user 8 presses on the lever comprising the gripping surface 13a to inflate the harness 20, and then the user places the breathing mask 10 against the face 8c in a usage position. In the usage position, the retaining device 40 assembly is released from the breathing mask 10.

As shown in FIG. 5, in the usage position the strap 40 is still attached to the harness 20, the portion of the secondary arm 43 of the strap 40 between the first connecting portion 44 and the second connecting portion 46 extending along the back of the user's head and being slightly taut. The main arm 41 of the strap 40, between the first connecting portion 44 and the gripping portion 42, is attached from the attachment portion 23 of the first inflatable tube 22 on the outward side of the portion of the secondary arm 43 of the strap 40 between the first connecting portion 44 and the second connecting portion 46.

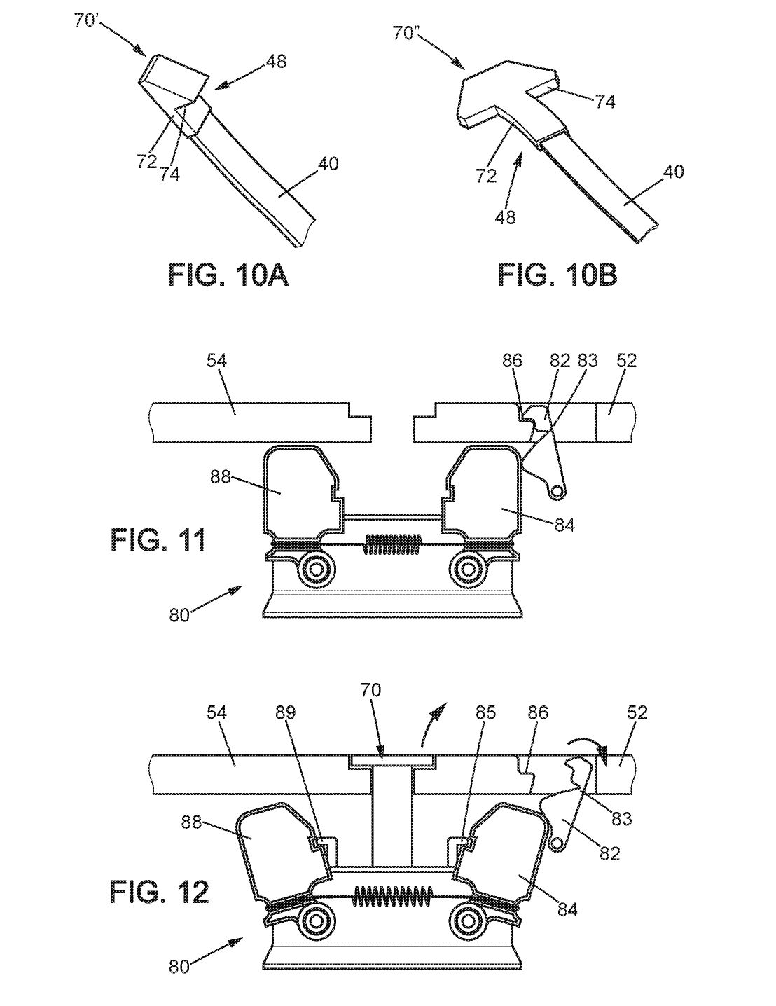

FIGS. 10A and 10B illustrate two variants of a retaining member consisting of hooks 70′, 70″. The hooks 70′, 70″ comprise a core 72 and a stop surface 74 extending substantially perpendicular to the core 72. When the breathing equipment 100 is in the stored position, the core 72 extends through a passage and the stop surface 74 bears against an engagement part 35′, illustrated in FIG. 7, located on the outer face 52b, 54b of the doors 52, 54. The passage is formed by an inward cutout in its periphery 55, defining a notch 58.

The advantage of having the engagement part 35, 35′ extending over the two doors 52, 54 is that the so-called Press-To-Test check can only be performed when the doors are closed.

Alternatively, according to the invention, the engagement part may only extend over the right door 54, in particular so that the passage is only created through one door 54.

FIGS. 11 and 12 illustrate a retaining device 80 which allows the doors 52, 54 not to be continuously open when the breathing assembly 100 is in use. The retaining device 80 comprises a hook 82 and an actuation member 84.

As illustrated in FIG. 11, when the breathing mask 10 is outside the housing 32, a hook 82 is in an active position and holds door 52 closed, with an abutment surface 86 of door 52 abutting against the hook 82. Alternatively, another actuation member 88 could similarly hold door 54 closed by means of another hook and an abutment surface of door 54.

A knob (not shown) located on the outer face 52b of door 52, or a direct action on the hook 82, brings the hook 82 into an inactive position as illustrated in FIG. 12, so that the door 52 opens to allow storing the breathing mask 10.

In addition, as illustrated in FIG. 12, the presence of the breathing mask 10 in the housing 32 causes rotation of the actuation members 84 and 88, bringing the hook 82 to the inactive position where it is at a distance from the abutment surface 86 of the door 52. As previously described, the retaining member 70 then can hold the doors 52, 54 in the closed position.

In the first embodiment illustrated in FIGS. 1 to 12, the actuation members 84, 88 are part of a latch, which is known per se, engaging with lugs 85, 89 that are integral with the support 11 of the breathing mask, the lugs 85, 89 engaging between the actuation members 84 and 88 to hold the breathing mask 10 in its stored position in the housing 32.

The hook 82 advantageously has a weakened area 83 where the hook 82 can be broken, to ensure that the door 52 can be opened in an emergency by exerting significant force on the door 52.

According to an alternative embodiment, instead of acting on the door 52, the retaining device 80 could act on the biasing device 60.

In particular, the retaining device 80 could act on the second portion 62b, 64b of the springs 62, 64 to obstruct the retaining device 80 by preventing it from pushing against the respective door 52, 54. The hook 82 could thus retain the second portion 62b, 64b of the springs 62, 64 when in the active position and allow the second portion 62b, 64b of the springs 62, 64 to push the doors 52, 54 open when the hook 82 is in the inactive position. This solution has the particular advantage of reducing the risk of the doors 52, 54 not opening when the user needs to put on the breathing mask 10.

Alternatively, the retaining device 80 could act on the first portion 62a, 64a of the springs 62, 64 by releasing the first portion 62a, 64a of the springs 62, 64 relative to the housing 32. For example, an intermediate element could be provided between the first part 62a, 64a of the springs 62, 64 and the housing 32, this intermediate element being movable and/or retractable.

According to another variant embodiment, instead of the retaining device 80, it is the retaining member 60 which could act on the biasing device 60. Thus, the engagement part 35 which comes into contact with the biasing device 60 could be located on the biasing device 60 instead of the closure device 50.

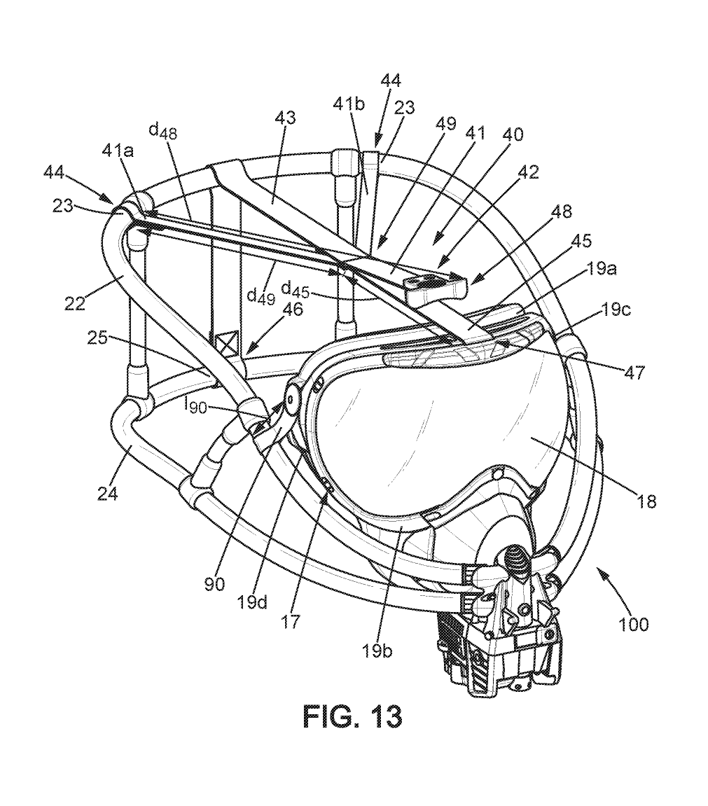

FIGS. 13 to 16 illustrate a second embodiment. The second embodiment differs from the first embodiment essentially in the breathing equipment 100 and in the retaining device 80, in an independent manner.

As illustrated in particular in FIG. 13 in the second embodiment, the secondary arm 43 of the strap 40 is connected to an intermediate portion 49 of the main arm 41, the intermediate portion 49 being distinct from the first connecting portion 44. More precisely, the intermediate portion 49 is distant from the first connecting portion 44 by an intermediate distance d₄₉. The secondary arm 43 of the strap 40 extends from the intermediate portion 49 to the second connecting portion 46 without being connected to the upper inflatable tube 22. However, to prevent the second connecting portion 46 from exerting pressure on the user's head when the breathing mask 10 is worn by the user, the secondary arm 43 of the strap 40 bears on the upper inflatable tube 22, meaning that the secondary arm 43 of the strap 40 circumvent (rest on) the upper inflatable tube 22.

The main arm 41 extends between the attachment portion 23 connecting to the upper inflatable tube 22 and the retaining portion 48, for a total length d₄₈. The intermediate distance d₄₉ is more than 20% of the total length d₄₈. Advantageously, the intermediate distance d₄₉ is substantially equal to the total length d₄₈.

The strap of the harness 20 further comprises a retaining arm 45 extending between a retaining portion 47 and a central portion connected to the main arm 41. The retaining portion 47 is fixed to the peripheral support 17, more specifically above the transparent lens 18, on the upper edge 19a.

In the second illustrated embodiment, the central portion consists of the intermediate portion 49. Alternatively, the central portion could be distant from the intermediate portion 49, in other words the portion of the main arm 41 to which the retaining arm 45 is fixed could be distinct from the portion of the main arm 41 to which the secondary arm 43 is fixed.

The retaining arm 45 has a length d₄₅ between the retaining portion 47 and the intermediate portion 49. The length d₄₅ is preferably between one half and twice the intermediate distance d₄₉; advantageously the length d₄₅ is substantially equal to the intermediate distance d₄₉.

Furthermore, in the second embodiment, the strap 40 comprises two attachment portions 23 connecting to the upper inflatable tube 22, the main arm 41 of the strap 40 dividing into two sub-arms 41a, 41b between the intermediate portion 49 and the attachment portions 23. The two sub-arms 41a, 41b form between them an angle advantageously between 45 degrees and 120 degrees.

Additionally and independently, the upper inflatable tube 22 is held on the side edge portions 19c 19d by two retaining tabs 90. Each retaining tab 90 is attached to a side edge portion 19c, 19d and loops around the upper inflatable tube 22, to allow the upper inflatable tube 22 to slide as it expands during inflation. Preferably, the retaining tabs 90 are flexible and made of thermoplastic elastomer, rubber, silicone, or similar. The length l90 of the retaining tabs 90 is preferably less than 3 centimeters, advantageously about 2 centimeters.

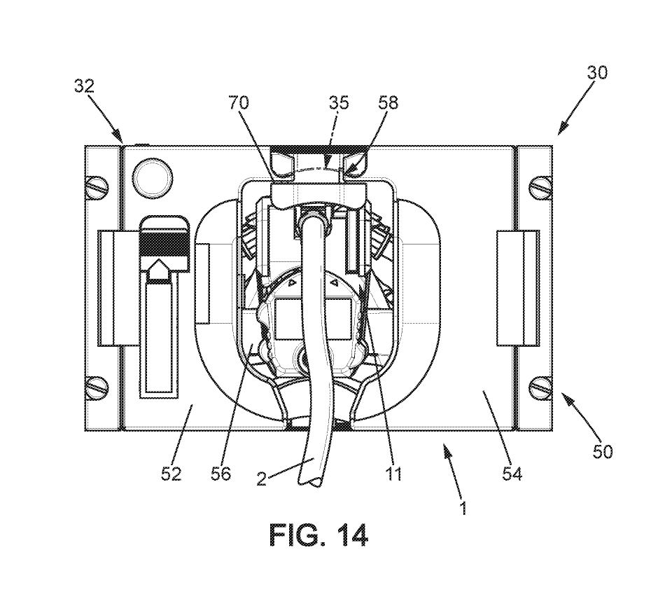

As illustrated in FIG. 14, passage 58 is in communication with passage 56 and has a width at least equal to the width of the strap 40 at the retaining portion 48. Thus, after placing the breathing equipment 100 in the housing 32 while holding the support 11 and the gripping portion 42 of the strap 40 or the retaining member 70 with hand 8a, the user closes the doors 52, 54 with hand 8b. As shown in bold lines in FIG. 14, the retaining member 70 and the retaining portion 48 of the strap 40 are then in the passage 56. Next, the user releases the support 11 and moves the retaining member 70 through the passage 58 to bring the stop surface 74 of the retaining member 70 to face the engagement part 35, as shown in phantom. The user can then release the retaining member 70.

As illustrated in FIG. 16, in the second embodiment, the engagement part 35 is placed at the bottom of a recess (depression) of complementary shape in the stop surface 74 of the retaining member 70.

As shown in FIG. 14, the passage 56 between the doors 52, 54 lies at a distance from the support 11, leaving a well of about one centimeter to prevent the doors 52, 54 from remaining closed due to the support 11 sticking between the doors 52, 54.

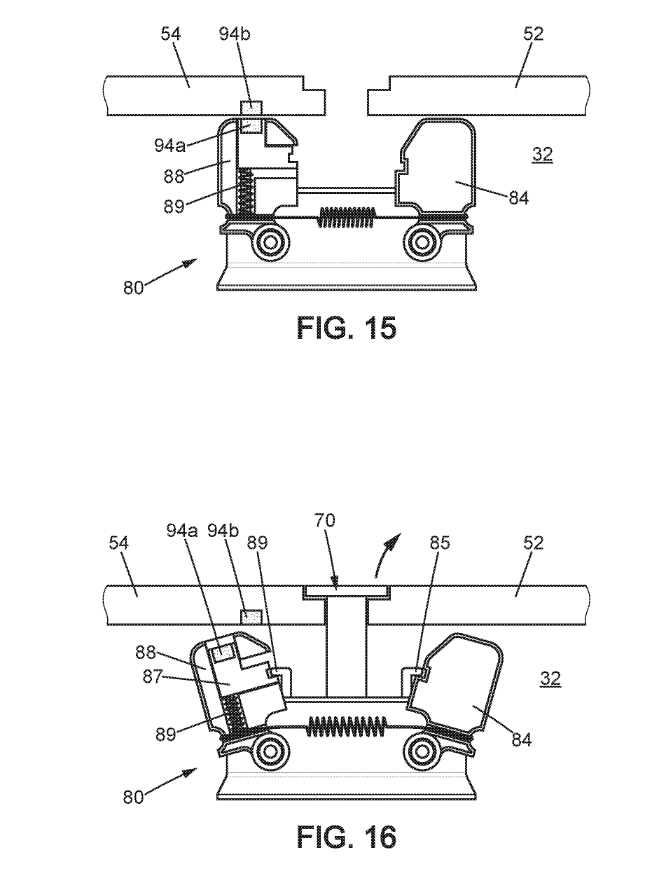

As illustrated in FIGS. 15 and 16, the retaining device 80 of the second embodiment differs from the retaining device of the first embodiment in that the hook 82 intended to engage with the abutment surface 86 and actuated by the actuation member 84 is replaced by a first magnet 94a intended to cooperate with a second magnet 94b and mounted in the actuation member 88 so as to slide between an active position illustrated in FIG. 15 and an inactive position illustrated in FIG. 16.

The actuation member 88 comprises a slider 87 biased by a spring 89 to an advanced position. When the slider 87 is in the advanced position and the door 54 is closed, the first magnet 94a is near the second magnet 94b, thereby holding the door 54 in the closed position against the action of the spring 64, due to the magnetic attraction between the first magnet 94a and the second magnet 94b.

When the breathing equipment 100 is in the usage position outside the housing 32, the slider 87 biased by the spring 89 is in the advanced position, so that the first magnet 94a is in the active position, at a distance from the second magnet 94b, thus keeping the door 54 in the closed position.

When the breathing equipment 100 is inserted into the housing 32 to bring it to the stored position, the lugs 85, 89 of the breathing mask 10 come into contact with the actuation members 84, 88 and in particular with the slider 87 which causes it to retreat against the action of the spring 89.

As illustrated in FIG. 16, when the slider 87 is in the retracted position, the first magnet 94a is in the inactive position recessed within the actuation member 88, so that it is necessary to position the retaining member 70 against the engagement part 35 in order to hold the doors 52, 54 closed against the biasing of the springs 62, 64.

Note that when door 54 is in the closed position, door 52 is held closed by a retaining flange (not shown) or similar arrangement.

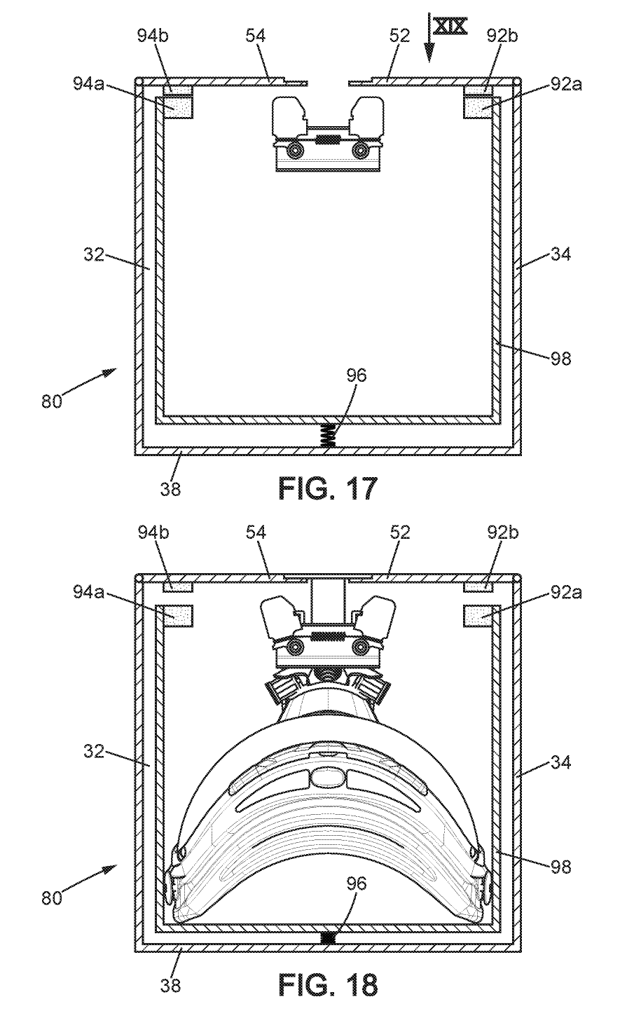

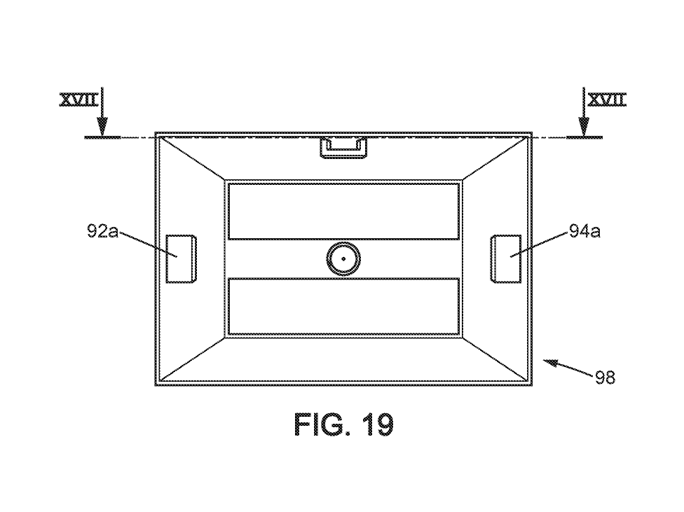

The third embodiment illustrated in FIGS. 17 to 19 differs from the first embodiment and from the second embodiment in the retaining device 80. For the other features, the breathing assembly of the third embodiment can have the features of the first embodiment and/or the second embodiment.

According to the third embodiment, the retaining device 80 comprises a chamber 98 mounted inside the housing 32 so as to slide between an advanced position illustrated in FIG. 17 and a retracted position illustrated in FIG. 18.

The chamber 98 is biased towards the advanced position by a spring 96. The retaining device 80 further comprises a first pair of magnets 92a, 94a mounted on the chamber 98 and a second pair of magnets 94a, 94b respectively mounted on the doors 52, 54.

When the slider 98 is in the advanced position, the first pair of magnets 92a, 94a is in the active position. When the doors 52, 54 are closed and the first pair of magnets 92a, 94a is in the active position, the first pair of magnets 92a, 94a is in proximity to the second pair of magnets 92b, 94b, thereby respectively retaining the doors 52, 54 in the closed position due to the magnetic attraction between each of the magnets of the first pair of magnets 92a, 94a and the corresponding magnet of the second pair of magnets 92b, 94b.

When the breathing equipment 100 is in the usage position outside the housing 32, the slider 98 biased by the spring 96 is in the advanced position, meaning the first pair of magnets 92a, 94a is in the active position, thus holding the doors 52, 54 in the closed position.

When the breathing equipment 100 is inserted into the housing 32 to return it to the stored position, the slider 98 is moved back into the inactive position by gravity, which tends to compress the spring 96.

As illustrated in FIG. 18, when the slider 98 is in the retracted position, the first pair of magnets 92a, 94a is in the inactive position away from the second pair of magnets 92b, 94b, so that positioning the retaining member 70 against the engagement part 35 is necessary to hold the doors 52, 54 closed against the biasing of the springs 62, 64.

As illustrated in FIG. 16, when the slider 87 is in the inactive position, the first magnet 94a is recessed within the actuating element 88, so that positioning the retaining member 70 against the engagement part 35 is necessary to hold the doors 52, 54 closed against the biasing of the springs 62, 64.

Naturally, the invention is not limited to these embodiments described for illustrative, non-limiting purposes. Thus, instead of being pivotally mounted on the housing 32, the doors 52, 54 could slide relative to the housing 32.

1. Breathing assembly for aircraft, comprising:
breathing equipment for supplying breathing gas to a user, comprising:
a breathing mask, the breathing mask comprising a rigid support and a shell attached to the rigid support, the shell having a breathing cavity and being adapted for application to the user's face around the user's mouth and nose,
an inflatable harness adapted to extend around the user's head opposite the shell in order to hold the shell on the user's face,
a strap having a gripping portion and a connecting portion, the connecting portion being attached to the harness,
a storage unit comprising:
a housing adapted to receive the breathing equipment in a stored position, said housing having an opening, and
a closure device comprising at least one door having an inner face and an outer face, the closure device being movable between a closed position where the closure device at least partially closes the opening and an open position where it is at least partially clear of the opening,
wherein:
the storage unit further comprises a biasing device able to act on the door to move the door away from the opening when the closure device is in the closed position,
the breathing equipment further comprises a retaining member attached to a retaining portion of the strap,
the storage unit comprises an engagement part adapted to engage with the retaining member to oppose the action of the biasing device and hold the closure device in the closed position, when the breathing equipment is in the stored position.

2. Breathing assembly according to claim 1, wherein the engagement part extends over the outer face of the door and abuts against the retaining member when the breathing equipment is in the stored position.

3. Breathing assembly according to claim 1, wherein:
the storage unit further comprises a retaining device having an active state and an inactive state,
the retaining device is able to oppose the action of the biasing device and keep the closure device in the closed position, when the retaining device is in the active state,
the retaining device is in the active state when the breathing mask is out of the storage unit, and
the retaining device is in the inactive state when the breathing equipment is in the stored position.

4. Breathing assembly according to claim 3, wherein the retaining device is breakable in order to release the closure device.

5. Breathing assembly according to claim 1, wherein the retaining member obstructs the biasing device when it is engaged with the engagement part.

6. Breathing assembly according to claim 1, wherein the strap is elastically extensible.

7. Breathing assembly according to claim 1, wherein the strap comprises:
a main arm extending between the gripping portion and the connecting portion, and
a retaining arm extending between a retaining portion fixed to the shell and a central portion attached to the main arm.

8. Breathing assembly according to claim 7, wherein:
the shell comprises a peripheral support supporting a transparent lens, and
the retaining portion is fixed to the peripheral support.

9. Breathing assembly according to claim 8, wherein:
the peripheral support comprises an upper edge portion extending above the transparent lens,
the retaining portion is fixed to the peripheral support near the upper edge portion.

10. Breathing assembly according to claim 7, wherein:
the main arm of the strap has a first distance between the connecting portion attached to the harness and the central portion,
the retaining arm has a second distance between the retaining portion fixed to the shell and the central portion, and
the second distance is between one half and twice the first distance.

11. Breathing assembly according to claim 1, wherein:
the harness comprises an upper tube and a lower tube,
the connecting portion constitutes a first connecting portion connected to an attachment portion of the upper inflatable tube,
the strap further comprises a secondary arm comprising a second connecting portion, the second connecting portion being connected to an attachment portion of the lower inflatable tube,
the secondary arm is not fixed to the upper inflatable tube.

12. Breathing assembly according to claim 11, wherein:
the secondary arm is connected to an intermediate portion of the main arm,
the intermediate portion is distanced from the first connecting portion by an intermediate distance,
the retaining portion is distanced from the first connecting portion by a total length, and
the intermediate distance is more than 20% of the total length.

13. Breathing assembly according to claim 1, wherein:
the harness comprises an extensible tube,
the shell comprises a peripheral support supporting a transparent lens, and
the extensible tube is held on the peripheral support by a retaining tab.

14. Breathing assembly according to claim 13, wherein:
the peripheral support comprises a side edge portion, and
the retaining tab is fixed to the side edge.

15. Breathing assembly according to claim 14, wherein the retaining tab is flexible and has a length of less than 3 centimeters.
